(19) United States
(12) Patent Application Publication
(10) Pub. No.: US 2003/0187684 A1
(43) Pub. Date: Oct. 2, 2003

(54) Apparatus and method for an automated negotiation

(76) Inventors: Claudio Bartolini, Menlo Park, CA (US); Wenbo Mao, Stoke Bristol (GB); Christopher William Preist, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/380,600

(22) PCT Filed: Jul. 30, 2002
(86) PCT No.: PCT/GB02/03466

(30) Foreign Application Priority Data
Jul. 31, 2001 (GB) 0118680.8

(51) Int. Cl. G06F 17/60

(52) U.S. Cl. 705/1

(57) ABSTRACT

A method and associated apparatus for negotiating automatically involve the following. A committing and undeniable negotiation proposal is submitted anonymously by a participant to a central server prior to agreement formation. The server matches a compatible proposal to the participant's committing and undeniable negotiation proposal to form an agreement. The server verifies, with the participant's collaboration, that the matched committing and undeniable proposal forming the agreement belongs to the participant.

### BACKGROUND OF THE INVENTION

1. Field of the Invention

The present invention relates to an apparatus and method for an automated negotiation.

2. Description of Related Art

The growth of electronic based trade and the explosion in electronic commerce (e-commerce) has spawned the development of automated trading systems in which each user delegates authority over some trade related decisions to an automated agent implemented in software. The agents interact using an agreed protocol to further the user's interests. For example, in the context of a commercial transaction in which a customer wishes to buy airline tickets, the customer may employ an agent which interacts with the automated agents of a third party in order to obtain the cheapest ticket fare for the customer's selected destination.

Improvements in communication systems and the accompanying increase in bandwidth has enabled transactions to take place far more frequently, quickly and cheaply than before. Market conditions are constantly changing making it difficult for human users to react quickly enough to trade (negotiate) in response to the fluctuating market conditions, hence the increase in use of automated transaction (negotiation) systems.

However, due to the increased dynamism of the e-commerce market place and the resulting short span of business relationships, trust, or a lack of it, has become a major issue. In the past, attempts to instil confidence to the participants of e-commerce market places has led to the introduction of admission procedures so that participants are vetted according to predetermined policies.

Another major concern for participants in e-commerce is the problem of fraud, especially that committed, for example, by dishonest arbiters or auctioneers who collude with participants. The fraudulent arbiters/auctioneers are able to make use of bid information accessible to them from the central servers, where admissions procedures take place, and where information relating to the bids or negotiations is processed or stored. It is assumed in present negotiation mechanisms that the arbiter or auctioneers can be trusted. Therefore the issue of trust needs to be addressed.

In spite of the security issues highlighted above, there is also a need for anonymity whilst conducting negotiations. In e-commerce settings, quite often, a party is obliged to declare its commitment, but the party may prefer its commitment not to be publicly verifiable. Known negotiation protocols, however, do not address the matter of privacy in general, and the need for separating accountability from privacy, in particular, and thus are not applicable to many market mechanisms including multivariate negotiation.

A problem further associated with some forms of e-commerce, such as electronic data interchange (EDI) is the need for participants to invest upfront in technology in order to conduct business. This can lead to the participants being technologically locked in to long term business relationships, preventing the participants from choosing short term trading relationships to satisfy their needs, and hindering competition.

### BRIEF SUMMARY OF THE INVENTION

According to a first aspect of the Invention, there is provided a method for a negotiating automatically comprising the steps of: submitting a committing and undeniable negotiation proposal anonymously from a participant to a centralised server prior to agreement formation; matching a compatible proposal to the participant's committing and undeniable negotiation proposal to form an agreement; and verifying that the matched committing and undeniable proposal forming the agreement belongs to the participant, with the participant's collaboration.

This approach offers the possibility of parties expressing commitment through negotiation proposals without such commitment being publicly verifiable. As can be seen from the description of a preferred embodiment that follows, this can provide assistance in a number of the areas of difficulty for automated negotiation indicated above.

According to a second aspect of the invention there is provided a method of participating in an automated negotiation, comprising: submitting a committing and undeniable negotiation proposal anonymously to a server; and on being advised that the committing and undeniable proposal has been matched to form an agreement, providing information to verify ownership of the committing and undeniable negotiation proposal.

According to a third aspect of the invention there is provided a method of automatically mediating a negotiation comprising the steps of: receiving a committing and undeniable negotiation proposal anonymously from a participant prior to agreement formation; matching a compatible proposal to the participant's committing and undeniable proposal to form an agreement; and verifying that the matched committing and undeniable proposal forming the agreement belongs to the participant.

According to a fourth aspect of the invention there is provided computing apparatus programmed for automated mediation of negotiation, comprising a processor programmed to: receive a committing and undeniable negotiation proposal anonymously from a participant to a centralised remote server prior to agreement formation; and match a compatible proposal to the participant's committing and undeniable proposal to form an agreement.

According to a fifth aspect of the invention there is provided computing apparatus for verifying ownership of a committing and undeniable negotiation proposal by a participant in a negotiation, comprising a processor programmed to: receive notification that a committing and undeniable negotiation proposal requires verification; and verify that the matched committing and undeniable proposal forming the agreement belongs to the participant.

According to a sixth aspect of the invention there is provided computing apparatus for automated mediation of a negotiation, comprising one or more processors together programmed to: receive a committing and undeniable negotiation proposal anonymously from a participant to a centralised remote server prior to agreement formation; match a compatible proposal to the participant's committing and undeniable proposal to form an agreement and verify that the matched committing and undeniable proposal forming the agreement belongs to the participant.

According to a seventh aspect of the invention there is provided data carrier having thereon code adapted to program a processor of computing apparatus to participate in an automated negotiation by: submitting a committing and undeniable negotiation proposal anonymously to a server; and on being advised that the committing and undeniable proposal has been matched to form an agreement, providing information to verify ownership of the committing and undeniable negotiation proposal.

### BRIEF DESCRIPTION OF THE DRAWINGS

Embodiments of the invention will now be described by way of example only, with reference to the drawings in which:

FIG. 1 shows a flow chart of a negotiation system suitable for incorporating an embodiment of the invention;

FIG. 2 shows a flow chart of the agreement formation process employed by the negotiation system of FIG. 1;

FIG. 3 shows a flow chart of a verification process incorporated within an embodiment of the invention for deterring and catching insider trading; and

FIG. 4 shows the elements of a negotiation system suitable for incorporating an embodiment of the invention.

### DETAILED DESCRIPTION OF THE INVENTION

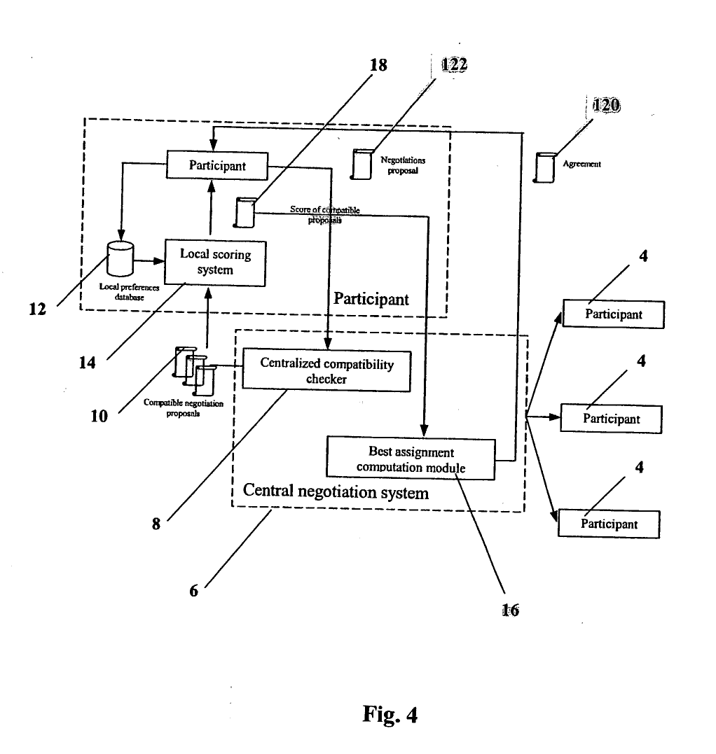

Before discussing embodiments of the invention, it is desirable to discuss the general. operation of an exemplary system for automated negotiation employing multiple market mechanisms to which embodiments of the present invention can be applied. Such an exemplary system is shown in FIG. 4.

After going through an admission process, each of the participants 4 to negotiation will submit proposals 122 that do not contain any expressions of preferences to a central compatibility checking engine 8 forming part of a central negotiator 6. In this second example the participants are three buyers B1, B2 and B3 and two sellers S1 and S2. The sellers submit proposals PB1, PB2, PB3, PS1 and PS2.

A set of compatible proposals is computed centrally using the centralised compatibility checking engine 8 and each participant 4 is notified of all the compatible proposals 10 to the one they have submitted. In this second example, it is assumed for simplicity that all of the sellers' proposals are compatible with all the buyers' proposals. So then each of the buyers receives notification of PS1 and PS2, and each of the sellers receives notification of PB1, PB2 and PB3.

Next, the participants 4 who submitted proposals 122 assign a relative score to competing compatible proposals 10 according to preferences stored in a local preferences' database 12 using a local module that acts as a private proposal evaluator 14. Given an outstanding proposal that has been submitted by one of the participant's counterparts, the local private proposal evaluator 14 will rank it against competing proposals based on the participant's preferences and assign relative scores to the compatible proposals. In this example, the scores are assigned as in the following

TABLE A

| | PB1 | PB2 | PB3 | PS1 | PS2 |
|---|---|---|---|---|---|
| B1 | | | | 52 | 48 |
| B2 | | | | 46 | 54 |
| B3 | | | | 59 | 41 |
| S1 | 32 | 38 | 30 | | |
| S2 | 39 | 31 | 40 | | |

From hereon there are two ways in which the best possible matching of compatible proposals is carried out.

In the first way, the relative scores 18 assigned to competing compatible proposals are then sent to a best assignment computation module 16 forming part of the central negotiator 6. The computation module 16 computes the best possible matching of proposals with respect to the relative score that each participant has declared.

To compute the best assignment, the following simplified table B can be computed, where for each entry B(Si,Bj), the weighted sum of A(Si,PBj) and A(Bj,PSi) is copied. A fair distribution of weights would take into account how many competing proposals there are on each side. In this example, to give the sellers an equal discrimination power as the buyers have, the sellers preferences should be weighed as 3/2 the buyers preferences.

In general it would write be written:

B(Si,Bj)=n*A(Si,PBj)+m*(Bj,PSi)

The weights could be skewed to give more relative importance to the buyers or sellers preferences if needed. A skewing factor can be introduced with a couple of integers ks, kb, and by defining the sellers skewing factor as ks/(ks+kb) and the buyers skewing factor as kb/(ks+kb). The formula becomes:

B(Si,Bj)=[ks/(ks+kb)]*n*A(Si,PBj)=[kb/(ks+kb)]*m*A(bj,PSi)

In this example, assuming ks=kb=1 (i.e. fair treatment of preferences of sellers and buyer), for the entry (B(S1 ,B1):

B(S1,B1)=3*A(S1,PB1)+2*A(B1,PS1)=3*32+2*52=96+104=200

Completing the table B, it would look as follows:

| | B1 | B2 | B3 |
|---|---|---|---|
| S1 | 200 | 206 | 208 |
| S2 | 183 | 201 | 202 |

The problem to solve now, is to find an assignment of each of the sellers to one buyer under the constraint that a buyer can be assigned to at most one seller, while maximizing the global utility. In the dual case, where the buyers outnumber the sellers, we would assign each buyer to one seller. The problem is equivalent to the maximised version of the Generalized Assignment Problem (GAP), from operations research, and can be formulated as follows:

Let there be m selling proposals submitted by the sellers S1 . . . Sm

Let there be n buying proposals submitted by the buyers B1 . . . Bn

Assume m<=n (or switch sellers with buyers if that is not true)

Let xij=1 when Si is assigned to Bj, in a possible solution of the generalized assignment problem; 0 otherwise

Let uij=the entry (Si,Bj) in the table we just computed. That is given by the relative score that Bj assigns to the proposal PSi plus the relative score that Si assigns to the proposal PBj.

The problem is now:

max S(i=1 . . . m; S(j=1 . . . n; xij*uji)

s.t. for each j=1 . . . n, S(i=1 . . . m; xij)<=1 (each j is assigned to exactly one i)

for each i=1 . . . m, S(j−=1 . . . n; xij)=1 (each i is assigned to exactly one j)

where S(i=1 . . . m(i) means the sum for I equals 1 to m of the quantities f(i)

The best assignment of selling proposals to buying proposals can be computed by applying well known algorithms for the solution of the generalized assignment problem.

In this example, the best assignment is then S1-B3 and S2-B2, for a global utility of 208+201=409.

Notice that B1's request will remain unsatisfied, and both S1 and S2 will not be assigned to their first choice.

In the second way aggregate scores are computer for each proposal from Table A, as follows:

| | B1 | B2 | B3 |
|---|---|---|---|
| S1 | 84 | 84 | 89 |
| S2 | 77 | 85 | 81 |

The problem to solve now, is to find an assignment of each of the sellers to each of the buyers, under the constraint that a buyer can be assigned to at most one seller and vice versa, while maximizing the global utility.

The problem is equivalent to the maximised version of the Assignment Problem (AP), from operations research, and can be formulated as follows:

Let there be n selling proposals submitted by the sellers S1 . . . Sn and n buying proposals submitted by the buyers B1 . . . Bn

Let xij=1 when Si is assigned to Bj, in a possible solution of the assignment problem; 0 otherwise

Let uij=the entry (Si, Bj) in the table above just computed. This is given by the relative score that Bj assigns to the proposal PSi plus the relative score that Si assigns to the proposal PBj.

The problem is now:

max S(I=1 . . . m; S(j=1 . . . n; xij*uij)

s.t. for each j=1 . . . n, S(I=1 . . . m;xij)=1 (each j is assigned to exactly one i)

for each i=1 . . . m, S(j−=1 . . . n; xij)=1 (each i is assigned to exactly one j)

where S(I=1 . . . m f(i)) means the sum for i equals 1 to m of the quantities f(i)

The best assignment of selling proposals to buying proposals can be computed by applying well known algorithms for the solution of the assignment problem.

In this example, the best assignment is then S1-B3 and S2-B2, for a global utility of 89=85=174.

Notice that B1's request will remain unsatisfied, and both S1 and S2 will not be assigned to their first choice.

Once the best possible assignment of compatible proposals is completed, the best assignment computation module will notify the participants of the formed agreement 20.

Both of the different techniques described above return the same assignment in the example presented. Though with the computation presented in the first alternative some weak proposals might be rewarded as it would be in the case that—everything else remaining the same—the rating of B1 of the seller proposals would be:

| | PB1 | PB2 | PB3 | PS1 | PS2 |
|---|---|---|---|---|---|
| B1 | | | | <57 | <43 |

This would increase the global utility of the assignment B1-S1. This means that the best strategy for the more populated group of traders (either buyers or sellers) would be to score one of the competing proposals very high, in the hope to maximize the global utility for that assignment. With the computation presented in the second alternative, each buyer (seller) is encouraged to be sincere in rating proposals instead.

Using the methods described above it is possible to separate objective proposal compatibility checking from subjective proposal fitness measuring based on preferences without giving the user preferences away, but by only computing a relative score for it.

The participants' preferences may also be stored in the form of a preference map on the local database for access in subsequent negotiations.

Embodiments of the present invention will now be described, indicating how employment of the present invention can improve the effectiveness of this type of system. Preferred embodiments of the invention employ convertible undeniable signatures to this end.

Convertible undeniable signatures are a form of digital encryption technology that has been used to prevent software piracy. However, existing proposals for protocols for convertible undeniable signatures are not concerned with negotiation, but are concerned solely with the way in which parties sign the proposals and the protocols that they follow to validate the signatures associated with the proposal.

Undeniable signatures are like ordinary digital signatures in that they cannot be re-pudiated, and thus a signatory cannot deny his or her commitment to a message or a contract at a later time. However the difference is that undeniable signatures are not universally verifiable. The concept of convertible undeniable signatures (see J. Boyar, D. Chaum, I. DamgÅrd, T. Pedersen, “Convertible undeniable signatures”, LNCS 537, Proc. Crypto '90, Springer Verlag, (1991), pp. 189-205) is an extension of the concept of undeniable signatures (see D. Chaum, H. van Antwerpen, “Undeniable Signatures”, LNCS 435, Proc. Crypto '89, Springer Verlag, (1990), pp. 212-216), whereby the signatory can convert, via a convertible scheme, undeniable signatures into universally verifiable signatures. Such convertible schemes are discussed in M. Michels, M. Stadler, “Efficient Convertible Undeniable Signature Schemes”, Proc. 4^{th} International Workshop on Selected Areas in Cryptography (SAC'97), Ottawa, Canada, pp. 231-244.

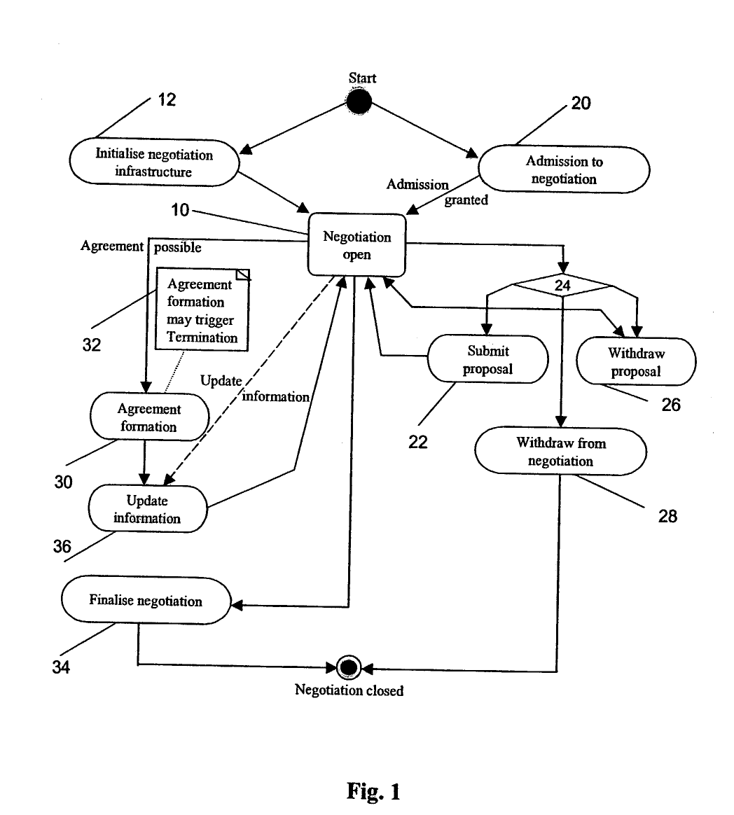

With reference to FIG. 1, in a preferred embodiment, convertible undeniable signatures are incorporated within the protocol for negotiation with multiple market mechanisms described above with reference to FIG. 4. Even though the proposals exchanged are truly anonymous, the participants to the negotiation protocol still have to be known in advance in order to be admitted to the negotiation 10 through an admissions process 20 which issues the participant with digital credentials. These digital credentials are then used to form an integral part of the committing and undeniable negotiation proposals submitted by the participant.

Whilst admission is being carried out, the negotiation infrastructure is initialised 12. Once this is done, participants start submitting proposals 22 that are signed with a convertible undeniable signature, therefore the proposals 22 cannot be proved to belong to a particular participant of the negotiation process, unless the participant collaborates in proving so.

The proposals 22 are received at a centralised negotiation server, i.e. a remote negotiation server that does not form part of the participants' local networks, which checks all proposals for compatibility and then returns details of compatible proposals 24 to the parties. This process is repeated for a participant until the participant decides to withdraw its proposal 26, or withdraw from the negotiation 28, or until a best matching compatible proposal is found for its proposal.

In the latter case an agreement may be formed which may trigger the withdrawal of the participants to the agreement from the negotiation 32.

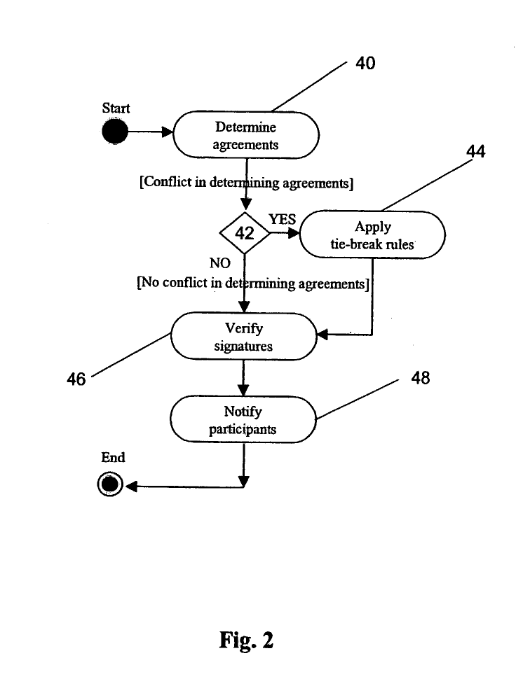

FIG. 2 illustrates the process of agreement formation 30 referred to in FIG. 1. Once a potential agreement has been determined 40, it is scrutinised for any conflicts 42. If, for example, more than one compatible proposal is found to be a best match for the party's proposal, then tie-break rules are applied 44 to determine which potential agreement should be formed. Once all conflicts are resolved, the determined agreement is subjected to verification 46 whereby the negotiation system uses a verification protocol in order to verify the convertible undeniable signatures used to sign the proposals. If verification is successful, the parties to the agreement are notified 48 of the agreement and negotiation is finalised 34. Information is also sent to the centralised negotiation server to update 36 the pool of proposals still to be matched.

The main properties of convertible, undeniable signatures are that:

A participant cannot prove that a signature is theirs if it is not;

A participant cannot prove that the signature belongs to a signatory unless the signatory collaborates in proving it; and

The signatory (a participant) cannot deny that the signature is in fact theirs, unless by refusing to collaborate in the revealing process.

By requiring that an agreed proposal is signed with a convertible, undeniable signature, the proposal general negotiation protocol has therefore the following properties:

When an agreement is formed, by matching compatible negotiation proposals, participants cannot claim ownership of the proposals if in fact they do not;

(Especially in one to one negotiation) when an agreement is formed, participants cannot endorse it for the third party, unless the counterpart is willing to collaborate in the revealing process;

When agreement is formed, by matching compatible negotiation proposals, participants cannot repudiate the proposals that they have submitted, unless by refusing to collaborate in the revealing process.

This mechanism is especially advantageous to prevent insider trading whilst providing a trading (negotiating) mechanism for the stock exchange that allows privacy of the parties.

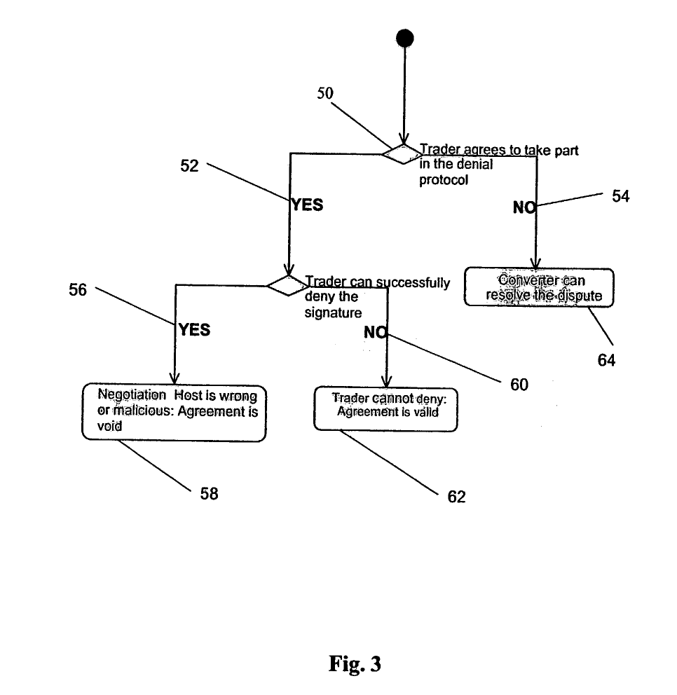

For example, with reference to FIG. 3, if a trader wants to enter into a negotiation for the buying or selling of shares, the trader must first go through an admission step 20 for which the trader must be known in advance. During admission the trader's identification is bound into a convertible undeniable signature. At this point the signature must be verified with a verification protocol 46 that involves the trader and the negotiation host. Any proposals submitted by the trader will be signed with the trader's convertible undeniable signature, thereby preserving the traders anonymity at this stage. If any of the trader's negotiation proposals 22 are matched to another compatible negotiation proposal, an agreement will be formed. If the trader forfeits the agreement, the negotiation host can enforce the trading to be completed. If the forfeiting trader objects to this decision, then the forfeiting trader has two choices. Either the trader agrees 52 to take part in a denial protocol 50 or the trader refuses 54 to take part in a denial protocol 50. In the former case, if the trader can successfully deny 56, then the negotiation host is wrong or malicious, and the agreement is considered void 58. If the trader fails in denying 60, the agreement is considered valid 62. But if the trader refuses to take part in a deniable protocol 54, a converter can resolve the dispute 64 by converting the signature. The converter should only be called into action in this latter case. Thus any trader engaged in insider trading will be found out.

A key feature is that of providing a reusable software infrastructure that allows the parties to negotiate in the above-described manner, as well as using any kind of market mechanism, including one-to-one bargaining, double auctions and multivariate mechanisms

An important security feature of the verifying protocol is that the central server which may run it, cannot show or run the protocol again because the central server does not have the secret key.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

1. A method of negotiating automatically comprising the steps of:
submitting a committing and undeniable negotiation proposal anonymously from a participant to a centralised remote server prior to agreement formation;
matching a compatible proposal to the participant's committing and undeniable proposal to form an agreement; and
verifying that the matched committing and undeniable proposal forming the agreement belongs to the participant.

2. A method according to claim 1, wherein the step of submitting is carried out by a buyer.

3. A method according to claim 1, wherein the steps of submitting, matching and verifying are repeated for each of a plurality of participants.

4. A method according to claim 1, wherein the committing and undeniable negotiation proposal relates to a plurality of parameters that are the subject of negotiation.

5. A method according to claim 4, wherein the step of matching comprises:
analysing the committing and undeniable negotiation proposal with respect to the parameters that are the subject of negotiation against corresponding parameters specified in the compatible proposals.

6. A method according to claim 1, wherein the step of verifying comprises:
issuing a request for verification from the participant; and
receiving information required for verification from the participant in response to the request.

7. A method according to claim 1, wherein the step of matching is conducted using a centralised remote negotiation engine.

8. A method according to claim 1, wherein the step of verifying is conducted using a verification module.

9. A method according to claim 1, wherein the steps of matching and verifying are conducted using a centralised remote negotiation engine.

10. A method according to claim 1, further comprising the steps of:
admitting the participant to the negotiation using an admissions process; and
initialising a negotiation infrastructure to be used, prior to the step of submitting the committing and undeniable negotiation proposal.

11. A method according to claim 10, wherein the step of admitting comprises:
issuing the participant with digital credentials.

12. A method according to claim 11, wherein the digital credentials issued to the participant form an integral part of the committing and undeniable negotiation proposal submitted by the participant.

13. A method according to claim 12, wherein the step of verifying comprises:
issuing a request for validation of the digital credentials from the participant; and
receiving information required for validation of the digital credentials from the participant in response to the request.

14. A method according to claim 1, wherein the committing and undeniable negotiation proposal is a negotiation proposal signed with a convertible undeniable signature.

15. A method of participating in an automated negotiation, comprising:
submitting a committing and undeniable negotiation proposal anonymously to a server; and
on being advised that the committing and undeniable proposal has been matched to form an agreement, providing information to verify ownership of the committing and undeniable negotiation proposal.

16. A method according to claim 15, wherein the committing and undeniable negotiation proposal relates to a plurality of parameters that are the subject of negotiation.

17. A method according to claim 15, wherein digital credentials have been issued to the participant, and wherein the digital credentials issued to the participant form an integral part of the committing and undeniable negotiation proposal submitted by the participant.

18. A method according to claim 15, wherein the committing and undeniable negotiation proposal is a negotiation proposal signed with a convertible undeniable signature.

19. A method of automatically mediating a negotiation comprising the steps of:
receiving a committing and undeniable negotiation proposal anonymously from a participant prior to agreement formation;
matching a compatible proposal to the participant's committing and undeniable proposal to form an agreement; and
verifying that the matched committing and undeniable proposal forming the agreement belongs to the participant.

20. A method according to claim 19, wherein the steps of receiving, matching and verifying are repeated for each of a plurality of participants.

21. A method according to claim 19, wherein the committing and undeniable negotiation proposal relates to a plurality of parameters that are the subject of negotiation, and the step of matching comprises:
analysing the committing and undeniable negotiation proposal with respect to the parameters that are the subject of negotiation against corresponding parameters specified in the compatible proposals.

22. A method according to claim 19, wherein the step of verifying comprises:
issuing a request for verification by the participant; and
receiving information required for verification from the participant in response to the request.

23. A method according to claim 19, further comprising the steps of:
admitting the participant to the negotiation using an admissions process; and
initialising a negotiation infrastructure to be used, prior to the step of receiving the committing and undeniable negotiation proposal.

24. A method according to claim 23, wherein the step of admitting comprises: issuing the participant with digital credentials.

25. A method according to claim 24, wherein the digital credentials issued to the participant form an integral part of the committing and undeniable negotiation proposal submitted by the participant, and the step of verifying comprises:
issuing a request for validation of the digital credentials from the participant; and
receiving information required for validation of the digital credentials from the participant in response to the request.

26. A method according to claim 19, wherein the committing and undeniable negotiation proposal is a negotiation proposal signed with a convertible undeniable signature.

27. Computing apparatus programmed for automated mediation of negotiation, comprising a processor programmed to:
receive a committing and undeniable negotiation proposal anonymously from a participant to a centralised remote server prior to agreement formation; and
match a compatible proposal to the participant's committing and undeniable proposal to form an agreement.

28. Computing apparatus according to claim 27, wherein the processor is programmed to receive and match proposals for each of a plurality of participants.

29. Computing apparatus according to claim 27, wherein the committing and undeniable negotiation proposal relates to a plurality of parameters that are the subject of negotiation.

30. Computing apparatus according to claim 29, wherein the processor is programmed to match proposals by analysing the committing and undeniable negotiation proposal with respect to the parameters that are the subject of negotiation against corresponding parameters specified in compatible proposals.

31. Computing apparatus according to claim 27, wherein the processor is further programmed to
admit a participant to the negotiation using an admissions process; and
initialise a negotiation infrastructure to be used prior to receiving the committing and undeniable negotiation proposal.

32. Computing apparatus according to claim 31, wherein the admissions process includes issuing the participant with digital credentials.

33. Computing apparatus according to claim 31, wherein the digital credentials enable the participant to include a convertible undeniable signature in the negotiation proposal.

34. Computing apparatus for verifying ownership of a committing and undeniable negotiation proposal by a participant in a negotiation, comprising a processor programmed to:
receive notification that a committing and undeniable negotiation proposal requires verification; and
verify that the matched committing and undeniable proposal forming the agreement belongs to the participant.

35. Computing apparatus according to claim 34, wherein the processor is programmed to:
issue the participant with digital credentials or receive digital credentials issued to the applicant; and
to verify the committing and undeniable negotiation proposal submitted by the participant using the digital credentials issued to the participant.

36. Computing apparatus for automated mediation of a negotiation, comprising one or more processors together programmed to:
receive a committing and undeniable negotiation proposal anonymously from a participant to a centralised remote server prior to agreement formation;
match a compatible proposal to the participant's committing and undeniable proposal to form an agreement and
verify that the matched committing and undeniable proposal forming the agreement belongs to the participant.

37. Computing apparatus as claimed in claim 36, wherein the one or more processors are further programmed to:
admit a participant to the negotiation using an admissions process; and
initialise a negotiation infrastructure to be used, prior to receiving the committing and undeniable negotiation proposal.

38. Computing apparatus as claimed in claim 37, wherein the admissions process includes issuing the participant with digital credentials.

39. Computing apparatus according to claim 38, wherein the digital credentials enable a participant to include a convertible undeniable signature in the negotiation proposal, and are used to verify that the matched committing and undeniable proposal forming the agreement belongs to the participant.

40. A data carrier having thereon code adapted to program a processor of computing apparatus to participate in an automated negotiation by:
submitting a committing and undeniable negotiation proposal anonymously to a server; and
on being advised that the committing and undeniable proposal has been matched to form an agreement, providing information to verify ownership of the committing and undeniable negotiation proposal.

41. A data carrier according to claim 40, wherein the code is adapted to program a processor to receive digital credentials for a participant, and to use the digital credentials to form an integral part of the committing and undeniable negotiation proposal submitted on behalf of the participant.

42. A data carrier according to claim 41, wherein the code is adapted to program a processor to sign the committing and undeniable negotiation proposal with a convertible undeniable signature.
